(19) United States
(12) Patent Application Publication
(10) Pub. No.: US 2015/0135879 A1
(43) Pub. Date: May 21, 2015

(54) STRUCTURE FOR MOUNTING PLANTABLE SHIFT LEVER ONTO BRACKET

(71) Applicants: Hyundai Motor Company, Seoul (KR); Kia Motors Corporation, Seoul (KR)

(72) Inventors: Won-Jin JEONG, Hwasung-shi (KR); Deok-Ki KIM, Hwasung-shi (KR); Sang-Yoon Kim, Seoul (KR); Min-Keun KWON, Buchun-shi (KR); Jeong-Seon MIN, Kwangjoo-shi (KR); Chang-Hyun LEE, Seoul (KR); Yang-Rae CHO, Suwon-shi (KR)

(73) Assignees: Hyundai Motor Company, Seoul (KR); Kia Motors Corporation, Seoul (KR)

(21) Appl. No.: 14/505,422

(22) Filed: Oct. 2, 2014

(30) Foreign Application Priority Data
Nov. 15, 2013 (KR) 10-2013-138773

(51) Int. Cl. F16H 59/10; F16H 59/02

(52) U.S. Cl. CPC F16H 59/10; F16H 59/0278
USPC 74/473.36

(57) ABSTRACT

A structure for mounting a plantable shift lever onto a bracket may include an extending part that protrudes from a front end of the plantable shift lever to extend forward, a dented part formed by denting a front end of the bracket forward to receive the extending part, a first penetrating hole formed to penetrate a rear end of the plantable shift lever in a left and right direction, a second penetrating hole formed to penetrate a rear end of the bracket in the left and right direction and positioned to correspond to the first penetrating hole, and a pin to be inserted into the first penetrating hole and the second penetrating hole to fix the plantable shift lever to the bracket. The plantable shift lever may be coupled to the bracket by inserting the extending part into the dented part and inserting the pin into the first penetrating hole and the second penetrating hole.

### CROSS-REFERENCE TO RELATED APPLICATIONS

The present application claims priority of Korean Patent Application Number 10-2013-138773 filed on Nov. 15, 2013, the entire contents of which application are incorporated herein for all purposes by this reference.

### BACKGROUND OF INVENTION

1. Field of Invention

The present invention relates to a structure for mounting a plantable shift lever onto a bracket, and more particularly, to a structure for mounting a plantable shift lever onto a bracket, capable of being automatically produced by inserting an extending part formed at a front end of the plantable shift lever into a dented part formed at a front end of the bracket and allowing a pin to pass through a first penetrating hole and a second penetrating hole to couple the plantable shift lever to the bracket.

2. Description of Related Art

In general, a transmission is a device that converts a power of an engine into rotational force and speed suitable for a traveling state of a vehicle to transmit driving wheels, and is greatly classified into a manual transmission and an automatic transmission.

A driver of the vehicle manipulates a consol around a driver's seat or a shift lever attached to a handle, and can change a gear shift level of the manual transmission or the automatic transmission to a desired gear shift level.

When the driver selects a gear suitable for the traveling of the vehicle by using the shift lever, movement of the shift level is transmitted to the manual transmission through a cable or a load. When the driver manipulates the shift lever, manipulation desired by the driver is transmitted to the automatic transmission by driving an inhibitor switch through a cable, and, thus, the driver travels as desired.

In the related art, since the above-stated shift lever is integrally manufactured with the bracket coupled to the vehicle body, there is a disadvantage in that when a consol layout is changed depending on a kind of the vehicle, it is necessary to newly manufacture a mold of the shift lever and the bracket.

In recent years, a separated type in which a plantable shift lever that includes operation components used in common and a bracket that is varied depending on a height and a design of a consol changed depending on the kind of the vehicle are separately provided and the plantable shift lever and the bracket are fastened to be fixed to the vehicle body has been developed, and the separated type has been increasingly used.

In case of the separated type, since the plantable shift lever is applicable to all kinds of vehicles in comparison to the integrated type, it is possible to the same quality for each kind of vehicles, and it is easy to manage the vehicle. Further, unlike the integrated type, since it is not necessary to develop a mold for each kind of vehicles, it is possible to reduce development cost.

As illustrated in FIG. 1, in a structure for mounting a plantable shift lever 1 onto a bracket 4 by using a separated type, the plantable shift lever 1 including operation components such as a knob 2 and a lever shaft 3 that are used in common is disposed above the bracket 4, and a bolt 5 is fastened at a portion 4 to mount the plantable shift lever 1 onto the bracket 4.

However, in the structure for mounting the plantable shift lever onto the bracket according to the related art, since the plantable shift lever is coupled by the bolt, a manufacturing process may be complicated, manufacturing cost may be increased, and a weight of the vehicle may be increased.

In order to mount the plantable shift lever through the bolting onto the bracket, it is necessary to accurately adjust positions of the plantable shift lever and the bracket to assemble. Furthermore, since a deviation between bolt fastening holes is highly likely to occur, automated production may not be easy.

When the lever shaft of the plantable shift lever is manipulated for a long time, since bolt fastening portions come loose, the plantable shift lever is separated in a back and forth direction and a left and right direction, so that friction noise may be caused when the lever shaft is operated.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to provide a structure for mounting a plantable shift lever onto a bracket, with which a manufacturing process is simple, manufacturing cost and a weigh of a vehicle body are reduced, automated production is easy, and friction noise is not caused when a lever shaft is operated by mounting the plantable shift lever onto the bracket by using an extending part of the plantable shift lever and a dented part of the bracket.

Various aspects of the present invention provide a structure for mounting a plantable shift lever onto a bracket, which couples the bracket of various heights and designs to a lower end of the plantable shift lever, and the plantable shift lever includes a lever shaft that operably changes a gear shift level of a vehicle. The structure may include an extending part that protrudes from a front end of the plantable shift lever to extend forward; a dented part that is formed by denting a front end of the bracket forward so as to receive the extending part; a first penetrating hole that is formed to penetrate a rear end of the plantable shift lever in a left and right direction; a second penetrating hole that is formed to penetrate a rear end of the bracket in the left and right direction and positioned to correspond to the first penetrating hole; and a pin that is to be inserted into the first penetrating hole and the second penetrating hole to fix the plantable shift lever to the bracket. The plantable shift lever may be coupled to the bracket by inserting the extending part into the dented part and inserting the pin into the first penetrating hole and the second penetrating hole.

The bracket may include a mounting part that is formed by denting the bracket downward so as to receive substantially the entire lower part of the plantable shift lever, and a fixing part that is formed at a lower end of the bracket so as to couple the bracket to a vehicle body.

The structure may further include a protrusion that protrudes upward from an upper front end of the extending part, and a protrusion receiving part that is formed by denting an inner surface of an upper part of the dented part upward so as to receive the protrusion. The plantable shift lever may be prevented from being separated in a back and forth direction by fastening the protrusion formed at the extending part of the plantable shift lever to the protrusion receiving part formed at the dented part of the bracket.

The structure may further include a pair of hinges that respectively protrude from sides of the plantable shift lever and extend in the left and right direction, and a pair of hinge receiving parts that are respectively formed by denting an inner surface of the bracket in the left and right direction so as to receive the hinges. The plantable shift lever may be prevented from being separated in the left and right direction by inserting and coupling the hinges formed at the plantable shift lever to the hinge receiving parts formed at the bracket.

A hinge in the pair of the hinges may have a substantially cylindrical shape with a substantially circular cross-section extending in the left and right direction, and a hinge receiving part in the pair of the hinge receiving parts may include an inlet into which the hinge is inserted and a pressing part in which the hinge is pressed, and have a “U” shaped cross-section. The inlet may have an inclined surface at a predetermined angle toward an inside of the hinge receiving part to minimize a tolerance generated when the plantable shift lever and the bracket are coupled.

The pin may be a spring pin that is formed by rolling an elastic steel plate in a substantially cylindrical shape to generate elastic force in a radial direction of the pin

According to various aspects of the present invention, since the structure for mounting a plantable shift lever onto a bracket has a simple structure in which the extending parts are inserted into the dented parts and the pin passes through the first penetrating hole and the second penetrating hole to couple the plantable shift lever to the bracket, a process of assembling the plantable shift lever with the bracket is simplified, manufacturing cost is reduced, and a weight of the vehicle body is reduced.

Unlike the related art using the bolting fastening method, since a method in which the plantable shift lever is inserted into the bracket to be mounted is used, it is easy to automatically produce an assembly of the coupled plantable shift lever and bracket.

Since the plantable shift lever can be prevented from being separated in the back and forth direction and the left and right direction by using the protrusions and the hinges, it is possible to remarkably reduce friction noise caused between the plantable shift lever and the bracket when the lever shaft is operated.

Since the plantable shift lever is applicable to all kinds of vehicles, it is possible to maintain the same quality regardless of the kind of the vehicle, and it is easy to manage the vehicle. Further, since it is not necessary to newly develop a mold for each kind of vehicles, development cost can be reduced.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram illustrating an example of a structure for mounting a plantable shift lever onto a bracket according to the related art.

FIG. 2 is a perspective view illustrating an exemplary plantable shift lever according to the present invention.

FIG. 3 is a perspective view illustrating an exemplary bracket according to the present invention.

FIG. 4 is a projection side view illustrating a state where an exemplary plantable shift lever is mounted on an exemplary bracket according to the present invention.

FIG. 5 is a projection side view illustrating a state where an exemplary plantable shift lever is mounted on an exemplary bracket according to the present invention.

FIG. 6 is an enlarged view of a portion A of FIG. 5.

FIG. 7 is an enlarged view of a portion B of FIG. 5.

FIG. 8 is a rear view illustrating a state where an exemplary plantable shift lever is coupled to an exemplary bracket according to the present invention.

FIG. 9A is a perspective view illustrating a state where an exemplary plantable shift lever and an exemplary bracket are coupled by a pin according to the present invention.

FIG. 9B is an enlarged view of the pin in FIG. 9A

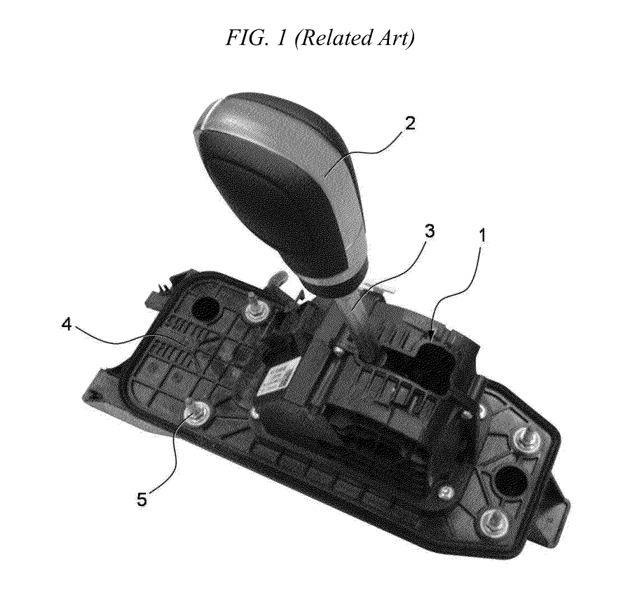

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

A structure for mounting a plantable shift lever 10 onto a bracket 20 according to various embodiments of the present invention, which couples the bracket 20 whose height and external design are varied depending on a kind of a vehicle to a lower end of the plantable shift lever 10 including a lever shaft 14 that is able to be operated so as to change a gear shift level of the vehicle. The structure includes extending parts 30 that protrude from a front end of the plantable shift lever 10 to extend forward, dented parts 40 that are formed by denting a front end of the bracket 20 forward so as to receive the extending parts 30, a first penetrating hole 16 that is formed to penetrate a rear end of the plantable shift lever 10 in a left and right direction, a second penetrating hole 26 that is formed to penetrate a rear end of the bracket positioned to correspond to the first penetrating hole 16 in the left and right direction, and a pin 70 that is coupled to pass through the first penetrating hole 16 and the second penetrating hole 26 to fix the plantable shift lever 10 to the bracket 20. The plantable shift lever 10 is coupled to the bracket 20 by inserting the extending parts 30 into the dented parts 40 and then allowing the pin 70 to pass through the first penetrating hole 16 and the second penetrating hole 26.

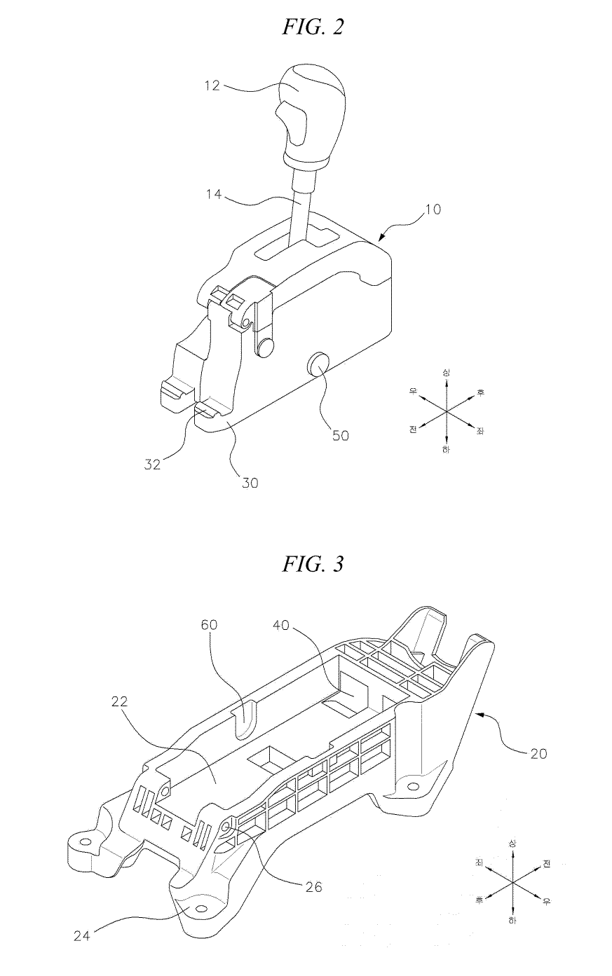

As illustrated in FIG. 2, the plantable shift lever 10 is configured as one common assembly by collecting operation components such as a knob 12 and the lever shaft 14 that are used in common regardless of the kind of the vehicle.

The knob 12 is configured to control a transmission by being held by a driver of the vehicle. A shape of the knob may be a circular shape or an elliptical shape or substantially a circular shape or an elliptical shape so as to allow the driver to conveniently hold and move the knob, and a material of the knob may be various materials such as plastic, rubber and leather.

The lever shaft 14 is a stick having a straight-line shape or substantially a straight-line shape coupled to a lower end of the knob 12 to be straightly slid and rotated, and serves to transmit manipulation of the driver through the knob 12.

As illustrated in FIG. 2, two extending parts 30 are formed to protrude forward from a lower front end of the plantable shift lever 10, and the two extending parts 30 are spaced apart from each other at a predetermined distance.

It is appreciated to those skilled in the art that one or a plurality of extending parts 30 may be formed depending on a kind of the plantable shift lever 10 and a coupling position relation of the plantable shift lever 10 and the bracket 20, the extending part may be formed at a central front end or an upper front end other than the lower front end, and a distance between the plurality of extending parts may be variously changed.

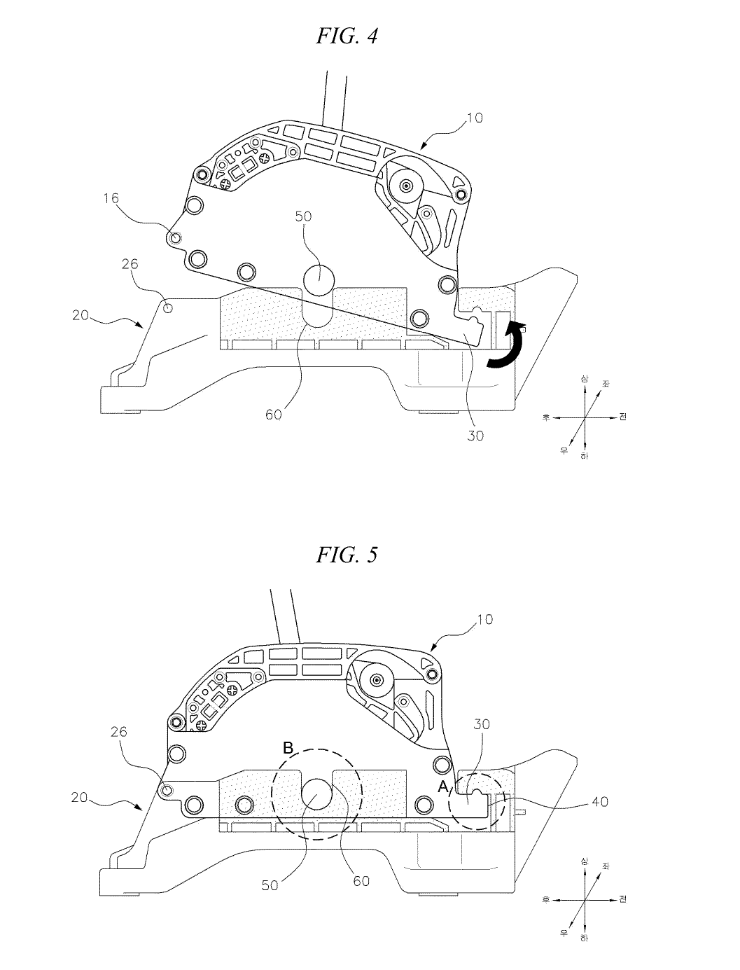

As illustrated in FIG. 4, a first penetrating hole 16 is formed at a lower rear end of the plantable shift lever 10 to penetrate the plantable shift lever 10 in the left and right direction so as to allow the pin 70 to be described below to be coupled.

As illustrated in FIGS. 3 and 4, the bracket 20 is coupled to the lower end of the plantable shift lever 10 to support the plantable shift lever 10 between a driver's seat and a passenger seat of the vehicle.

In addition to supporting the plantable shift lever 10, the bracket 20 is varied depending on the size and purpose of the vehicle to adjust a height of the plantable shift lever 10 and to improve an internal environment of the vehicle.

As illustrated in FIG. 3, the bracket 20 includes a mounting part 22 having a shape dented downward so as to receive the entire lower part or substantially the entire lower part of the aforementioned plantable shift lever 10, and a fixing part 24 for coupling the bracket 20 to the vehicle body to be fixed.

After the plantable shift lever 10 is mounted on the mounting part 22, the plantable shift lever 10 and the bracket 20 are fastened, and an assembly of the fastened plantable shift lever 10 and bracket 20 is coupled to the vehicle body through bolting by the fixing part 24. By doing this, the plantable shift lever 10 is attached to the vehicle.

As illustrated in FIG. 3, the dented parts 40 are formed at an upper front end of the bracket 20 to be dented forward so as to receive the extending parts 30 of the aforementioned plantable shift lever 10.

The dented part 40 may have a shape corresponding to the extending part 30 of the plantable shift lever 10. Similarly to the extending part, one or a plurality of dented parts may be formed depending on a kind of the plantable shift lever 10 and a coupling position relation of the plantable shift lever 10 and the bracket 20, and may be variously disposed at an upper part or a center.

As illustrated in FIG. 3, the second penetrating hole 26 is formed at an upper rear end of the bracket 20 to penetrate the bracket 20 in the left and right direction so as to correspond to the first penetrating hole 16 of the aforementioned plantable shift lever 10.

As illustrated in FIGS. 4 and 5, the first penetrating hole 16 and the second penetrating hole 26 are preferably formed to accurately coincide with each other when the plantable shift lever 10 is mounted on the mounting part 22 of the bracket 20.

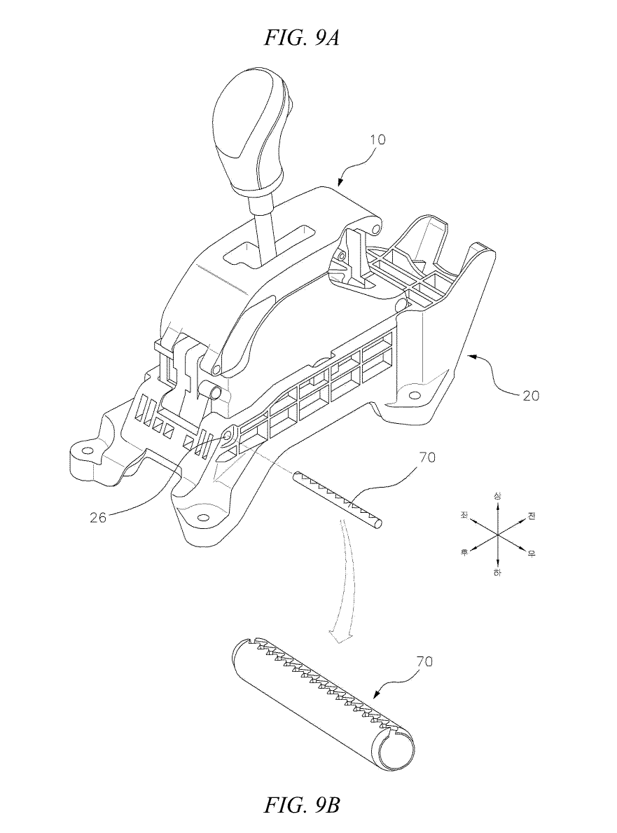

As illustrated in FIGS. 9A and 9B, after the plantable shift lever 10 is mounted on the bracket 20, the pin 70 passes through the first penetrating hole 16 and the second penetrating hole 26, so that a fastening procedure of the plantable shift lever 10 and the bracket 20 is finished.

As illustrated in FIGS. 9A and 9B, the pin 70 is preferably a spring pin formed by rolling a steal plate made of an elastic material in a cylindrical shape to generate elastic force in a radial direction of the pin 70, that is, in an outward direction with a center of a circle its reference.

As described above, by using the spring pin, it is possible to prevent the plantable shift lever 10 from being separated due to a deviation between the first penetrating hole 16 and the second penetrating hole 26, and since the elastic force is continuously generated in the radial direction, it is possible to maintain fastening force for a long time.

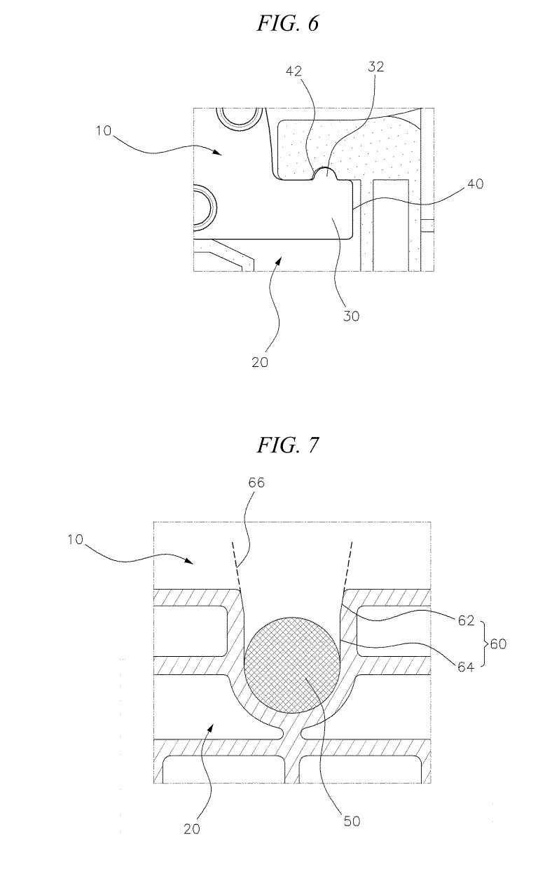

As illustrated in FIGS. 5 and 6, a protrusion 32 is formed to protrude upward from an upper part of the extending part 30, and a protrusion receiving part 42 is formed at an upper part of the dented part 40 to be dented upward so as to receive the protrusion 32. That is, the plantable shift lever 10 is coupled to the bracket 20 by inserting the extending parts 30 of the plantable shift lever 10 into the dented parts 40 of the bracket 20 and engaging the protrusions 32 with the protrusion receiving parts 42 at the same time.

The protrusion receiving part 42 is formed in a shape corresponding to the protrusion 32, and in the illustrated exemplary embodiment, the protrusion 32 is formed in a semi-cylindrical shape the protrusion, but may be formed in various shapes depending on a kind of the plantable shift lever 10.

As mentioned above, when the plantable shift lever 10 and the bracket 20 are fastened, the protrusions 32 and the protrusion receiving parts 42 are fastened, so that it is possible to restrict the movement of the plantable shift lever 10 in a back and forth direction.

As illustrated in FIGS. 2 and 3, a pair of hinges 50 protrudes from left and right sides of the lower part of the plantable shift lever 10 to extend in the left and right direction, and a pair of hinge receiving parts 60 are formed at left and right inner surfaces of the bracket 20 to be dented in the left and right direction.

As illustrated in FIGS. 5, 7 and 8, the hinge 50 preferably has a cylindrical shape or substantially a cylindrical shape, in which a circular cross-section or substantially a circular cross-section is formed to protrude in the left and right direction, and the hinge receiving part 60 preferably includes an inlet 62 into which the hinge 50 is inserted so as to receive the hinge 50, and a pressing part 64 in which the hinge 50 is pressed.

As illustrated in FIG. 7, the hinge receiving part 60 preferably has a substantially “U” shape, and the inlet 62 is preferably formed as an inclined surface 66 having a predetermined inclined angle toward the inside of the hinge receiving part 60.

The pressing part 64 of the hinge receiving part 60 has a width in the back and forth direction, which is relatively smaller than a diameter of the hinge 50, so that the hinge 50 is preferably inserted into and coupled to the hinge receiving part 60.

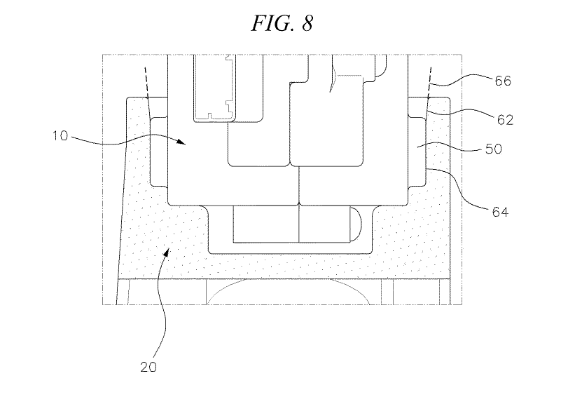

As illustrated in FIG. 8, when the bracket 20 is viewed from the back, left and right sides of the hinge receiving part 60 are preferably formed as inclined surfaces 66 having a predetermined inclined angle toward the inside of the hinge receiving part 60.

That is, widths of the hinge receiving part 60 in the back and forth direction and the left and right direction are gradually narrowed as the hinge receiving part is closer to pressing part 64 from the inlet 62. The inclined surface 66 formed at the inlet 62 serves to absorb tolerance generated when the plantable shift lever 10 and the bracket 20 are coupled.

As mentioned above, since the hinges 50 formed at the plantable shift lever 10 are inserted into and coupled to the hinge receiving parts 60 formed at the bracket 20, it is possible to restrict the movement of the plantable shift lever 10 in the left and right direction.

An exemplary assembly procedure of mounting the plantable shift lever 10 onto the bracket 20 according to the exemplary embodiment of the present invention is as follows.

As illustrated in FIG. 4, the plantable shift lever 10 is obliquely positioned above the bracket 20, and the extending parts 30 of the plantable shift lever 10 are inserted into the dented parts 40 of the bracket 20.

Subsequently, as illustrated in FIGS. 4 and 5, the entire lower part or substantially the entire lower part of the plantable shift lever 10 is mounted on the mounting part 22 of the bracket 20 by rotating the plantable shift lever 10 in a counterclockwise direction in the illustrated exemplary embodiment. At this time, the protrusions 32 and the hinges 50 formed at the plantable shift lever 10 are respectively received by the protrusion receiving parts 42 and the hinge receiving parts 60 formed at the bracket 20 to restrict the movement of the plantable shift lever 10.

As illustrated in FIGS. 9A and 9B, the plantable shift lever 10 is mounted on the bracket 20 and the pin 70 is inserted into the first penetrating hole 16 formed in the plantable shift lever 10 and the second penetrating hole 26 formed in the bracket 20, so that the plantable shift lever 10 and the bracket 20 are completely coupled.

Finally, the assembly of the completely coupled plantable shift lever 10 and bracket 20 is coupled to the vehicle body to be fixed using the fixing part 24 formed at the bracket 20, so that the plantable shift lever 10 is attached to the vehicle body.

For convenience in explanation and accurate definition in the appended claims, the terms “upper” or “lower”, “front” or “rear”, “downward” or “upward”, “left” or “right”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A structure for mounting a plantable shift lever onto a bracket, wherein the structure couples the bracket of various heights and designs to a lower end of the plantable shift lever, and the plantable shift lever includes a lever shaft that operably changes a gear shift level of a vehicle, the structure comprising:
an extending part that protrudes from a front end of the plantable shift lever to extend forward;
a dented part that is formed by denting a front end of the bracket forward so as to receive the extending part;
a first penetrating hole that is formed to penetrate a rear end of the plantable shift lever in a left and right direction;
a second penetrating hole that is formed to penetrate a rear end of the bracket in the left and right direction and positioned to correspond to the first penetrating hole; and
a pin that is to be inserted into the first penetrating hole and the second penetrating hole to fix the plantable shift lever to the bracket,
wherein the plantable shift lever is coupled to the bracket by inserting the extending part into the dented part and inserting the pin into the first penetrating hole and the second penetrating hole.

2. The structure of claim 1, wherein the bracket includes:
a mounting part that is formed by denting the bracket downward so as to receive substantially the entire lower part of the plantable shift lever; and
a fixing part that is formed at a lower end of the bracket so as to couple the bracket to a vehicle body.

3. The structure of claim 1, further comprising:
a protrusion that protrudes upward from an upper front end of the extending part; and
a protrusion receiving part that is formed by denting an inner surface of an upper part of the dented part upward so as to receive the protrusion,
wherein the plantable shift lever is prevented from being separated in a back and forth direction by fastening the protrusion formed at the extending part of the plantable shift lever to the protrusion receiving part formed at the dented part of the bracket.

4. The structure of claim 1, further comprising:
a pair of hinges that respectively protrude from sides of the plantable shift lever and extend in the left and right direction; and
a pair of hinge receiving parts that are respectively formed by denting an inner surface of the bracket in the left and right direction so as to receive the hinges,
wherein the plantable shift lever is prevented from being separated in the left and right direction by inserting and coupling the hinges formed at the plantable shift lever to the hinge receiving parts formed at the bracket.

5. The structure of claim 4, wherein:
a hinge in the pair of the hinges has a substantially cylindrical shape with a substantially circular cross-section extending in the left and right direction, and
a hinge receiving part in the pair of the hinge receiving parts includes an inlet into which the hinge is inserted and a pressing part in which the hinge is pressed, and has a “U” shaped cross-section.

6. The structure of claim 5, wherein the inlet has an inclined surface at a predetermined angle toward an inside of the hinge receiving part to minimize a tolerance generated when the plantable shift lever and the bracket are coupled.

7. The structure of claim 1, wherein the pin is a spring pin that is formed by rolling an elastic steel plate in a substantially cylindrical shape to generate elastic force in a radial direction of the pin.
